(19) United States
(12) Patent Application Publication
(10) Pub. No.: US 2007/0194103 A1
(43) Pub. Date: Aug. 23, 2007

(54) Determining information about documents

(75) Inventor: Gene Manheim, Sunnyvale, CA (US)

Correspondence Address: DAVID LEWIS, 1250 AVIATION AVE., SUITE 200B, SAN JOSE, CA, 95110, US

(73) Assignee: Inlite Research, Inc.

(21) Appl. No.: 11/360,929

(22) Filed: Feb. 22, 2006

(51) Int. Cl. G07F 19/00; G06K 19/00

(52) U.S. Cl. 235/379; 235/487

(57) ABSTRACT

A code is included on documents. The code may include information that may be used to locate, within a database, information associated with the document. In an embodiment, the information in the database is used to authenticate the document. In an embodiment, the code is a barcode. In an embodiment, the code may include an identifier identifying an institution associated with the database and an identifier identifying a data structure within the database. The above embodiments may be used together and/or separately form one another.

### FIELD

This specification relates to determining information about one or more documents.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subjection matter in the background section merely represents different approaches, which in and of themselves may also be inventions.

Documents are produced in a number of different settings for a number of different purposes. At times it may be desirable to find out information about a document.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1A shows a system within which documents are circulated.

FIG. 1B shows a system within which documents are circulated, which is an embodiment of FIG. 1A.

FIG. 2 shows a document having a code and other document elements, which is an embodiment of one of the documents of FIG. 1A.

FIG. 3 shows an embodiment of the code of FIG. 2.

FIG. 4 shows a check, which is an embodiment of the documents of FIGS. 1A-3.

FIG. 5 shows a block diagram of a machine that may be used for one or more of the members of the system of FIG. 1A.

FIG. 6 shows an embodiment of the memory system of FIG. 5.

FIG. 7 shows an embodiment of the memory system of FIG. 5.

FIG. 8 shows a flowchart of an embodiment of a method for authenticating a document of FIGS. 1A-4.

FIG. 9A shows a flowchart of an embodiment of a method for entering a document into the system of FIG. 1A or 1B.

FIG. 9B shows a flowchart of an embodiment of a method for updating a database of the system of FIG. 1B.

FIG. 10 shows a flowchart of an embodiment of a method of configuring equipment at an institution or other entity of a system of FIG. 1A.

### DETAILED DESCRIPTION OF SOME EXAMPLES OF SOME EMBODIMENTS OF THE INVENTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

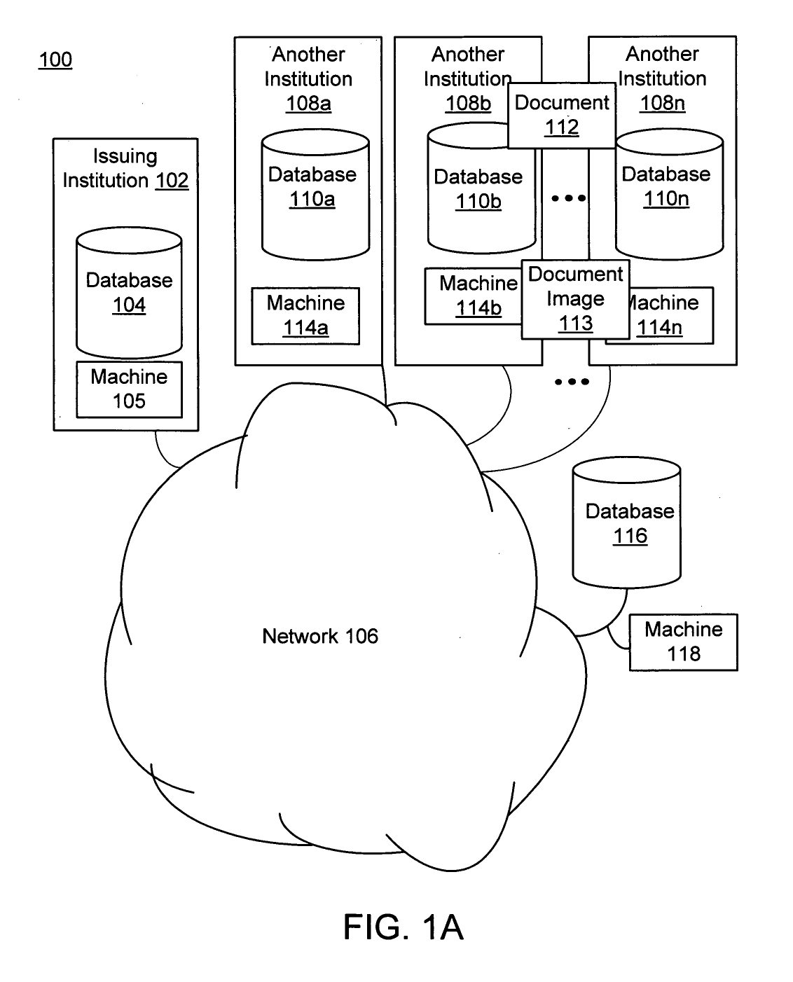

In general, at the beginning of the discussion of each of FIGS. 1A-7 is a brief description of each element, which may have no more than the name of each of the elements in the one of FIGS. 1A-7 that is being discussed. After the brief description of each element, each element is further discussed in numerical order. In general, each of FIGS. 1A-10 is discussed in numerical order and the elements within FIGS. 1A-10 are also usually discussed in numerical order to facilitate easily locating the discussion of a particular element. Nonetheless, there is no one location where all of the information of any element of FIGS. 1A-10 is necessarily located. Unique information about any particular element or any other aspect of any of FIGS. 1A-10 may be found in, or implied by, any part of the specification.

FIG. 1A shows a system 100, within which documents are circulated. System 100 may include issuing institution 102, database 104, machine 105, network 106, other institutions 108a-n, database, 110a-n, document 112, document image 113, machine 114, database 116, and machine 118. In other embodiments, system 100 may not have all of the components listed above and/or may have other components in addition to, or instead of, those listed above.

The lines connecting the boxes representing the above listed elements represent the communication links between the entities connected by the lines. In this specification, the word institution may refer to any entity where a collection of information related to documents is located or any entity that makes use of information in a collection of information stored elsewhere, which may include zero, one, or more people, such as an organization, company, or individual. For example, the institutions may be different individuals or groups of individuals within an organization that have different roles and system 100 may be used for internally authenticating internal documents, for example. In an example in which at least two of the institutions are different parts of the same organization, system 100 could be used to verify that incorrect information was not falsely or accidentally entered into a document by an employee. In an embodiment, each institution's decisions related to a document in question are independent of other institutions. In an embodiment (e.g., an embodiment in which the document is a check), each institution's decisions regarding a check in question are independent of other institutions. In an embodiment, each institution's monetary decisions are not influenced by other institutions. In an embodiment, each institution's monetary decisions are not influenced by other institutions. In an embodiment, each institution's decisions are not influenced by other institutions.

System 100 is a group of at least two entities that transfer information about documents from one entity to another entity. Issuing institution 102 may be one of the entities of system 100. Issuing institution 102 may issue one or more documents whose authenticity may need to be authenticated at a later time and/or at another institution. In this specification, the word authenticate is to be understood as generic to the word validate. In this specification, any place the word “authenticate” or a conjugation of the word authenticate is used (such as the word authenticity), it may be replaced with the word validate or a corresponding conjugation of the word validate to obtain a specific embodiment. Additionally, it may be desirable to obtain information related to the document issued by issuing institution 102 for other reasons. In an embodiment issuing institution 102 may also print documents, or the documents may be printed by another institution prior to issuance.

Database 104 is optional and may store information related to documents issued by issuing institution 102. In this specification, the word database may refer to any collection of data. In an embodiment, the collection of data is organized in a particular manner. A database, such as database 104, may include a collection of database structures, such as records and/or information. However, in an embodiment, database 104 may be any collection of data, such as data located in files that are arranged in folders. In another embodiment, database 104 may include any collection of data structures, such as records, stored in a computer in a systematic way, such that a computer program may consult the database to answer questions (e.g., via queries).

A database may include a structural description of the type of facts held in the database, which may be referred to as a schema. The schema describes the objects that are represented in the database, and the relationships among them. There are a number of different ways of organizing a schema, which may be referred to as modeling the database structure. The different ways of organizing the schema may be referred to as database models (or data models). One of the models that may be used in database 104 is a relational model, which represents all information in the form of multiple related data containers each consisting of rows and columns. This model represents relationships by the use of values common to more than one data container. Some other models that may be used for database 104 are the hierarchical model, the object-relational model, and the network model, which may use a more explicit representation of relationships.

In an embodiment, database 104 may include data that is managed to ensure the data's integrity and quality, the database allows shared access by a community of users, the data has a schema, and/or the data supports a query language. For better retrieval and sorting, each record may be organized as a set of data elements, which may be referred to as facts. The items retrieved in answer to queries become information that can be used to make decisions. The software for accessing the data may be referred to as a Database Management System (DBMS). The database management system may be used to manage and query a database. In a database management system, data is stored in one or more data containers, each container contains records, and the data within each record is organized into one or more fields. In relational database systems, the data containers are referred to as data containers, the records are referred to as rows, and the fields are referred to as columns (in terms of the relational model of databases, a data container can be considered a convenient representation of a relation). In object oriented databases, the data containers are referred to as object classes, the records are referred to as objects, and the fields are referred to as attributes. Similarly, another data container is a graph including tuple (which are analogous to rows) having attributes (which are analogous to columns). Other database architectures may use other terminology. The present invention is not limited to any particular type of data container or database architecture. However, for the purpose of explanation, the examples and the terminology used herein are often those associated with relational databases. The terms data container, graph, and data container may be substituted one for another wherever they appear to obtain different embodiments, but the term data container is generic to data container and graph. The terms field, attributes, and columns may be substituted one for another wherever they appear to obtain different embodiments, but the term data field is generic to column and attribute. The terms row, record, tuple, and data structure may be substituted one for another wherever they appear to obtain different embodiments, but the term data structure is generic to record, tuple, and row. Additionally, although for ease in reading the word database is used through out the specification, the broader term data-location may be substituted for the word database wherever the word database is used.

In the context of a relational database, a record—also called a row or tuple—represents a single, implicitly structured data item in a data container. Each record in a data container represents a set of related data, and in an embodiment every record in the data container has the same structure. For example, in a data container that represents companies, each record would represent a single company. Columns might represent values such as the company name, company street address, whether the company is publicly held, the companies VAT number, etc. In a data container that represents the association of employees with departments, each record may associate one employee with one department. The implicit structure of a record, and the meaning of the data values in a record, may include a succession of data values, one in each column of the data container. The record may be interpreted as composed of a set of tuples in which each tuple may include the name of the relevant column and the value this row provides for that column. Each column may accept a data value of a particular type. For example, one column might require a unique identifier, another might require text representing a person's name, another might require an integer representing hourly pay.

In a Relational Database (RDB) a table is a set of data elements (cells) that may be organized, defined, and stored as horizontal rows and vertical columns where each item can be uniquely identified by a label, which may be referred to as a key or by the item's position in relation to other items. A table may have a specified number of fields, but can have any number of records. In an embodiment a row within a table of database 104 may not contain repeating fields. In another embodiment, the rows may contain repeating fields. In an embodiment, a table within database 104 may contain a header and a main data table. The main data table may contain the actual structured data, which may include a value stored at the intersection of each row and column. The header may include one or more sets of constraints, such as a set of constraints for the whole table, and possibly one set of constraints for each column. In non-relational databases, such as in a hierarchical database, the equivalent of a table may be a file that includes one or more records (the rows) and fields (the columns). In one embodiment, a database table of database 104 cannot take arbitrary information in any cell, and nor can values be represented as formulae referring to other cells. For example, the data type of each field may be strictly defined within the database management system as part of the design of a particular database.

In an embodiment, database 104 may contain data that may be used for the authentication of documents. Database 104 may store information in files that contain data structures (e.g., records), and the data structures may include several fields. Database 104 may contain several data containers (such as tables), each data container having one or more data structures. Alternatively, the database may have one or more objects that are linked to one another. The data structures may themselves be objects. In one embodiment each data structure is associated with a document. In other embodiments, each data structure is associated with part of a document, a document, a portion of multiple documents, or a group of documents. Data in the data structures may be used for authenticating the document against data obtained from the document at the time the document is presented to an institution.

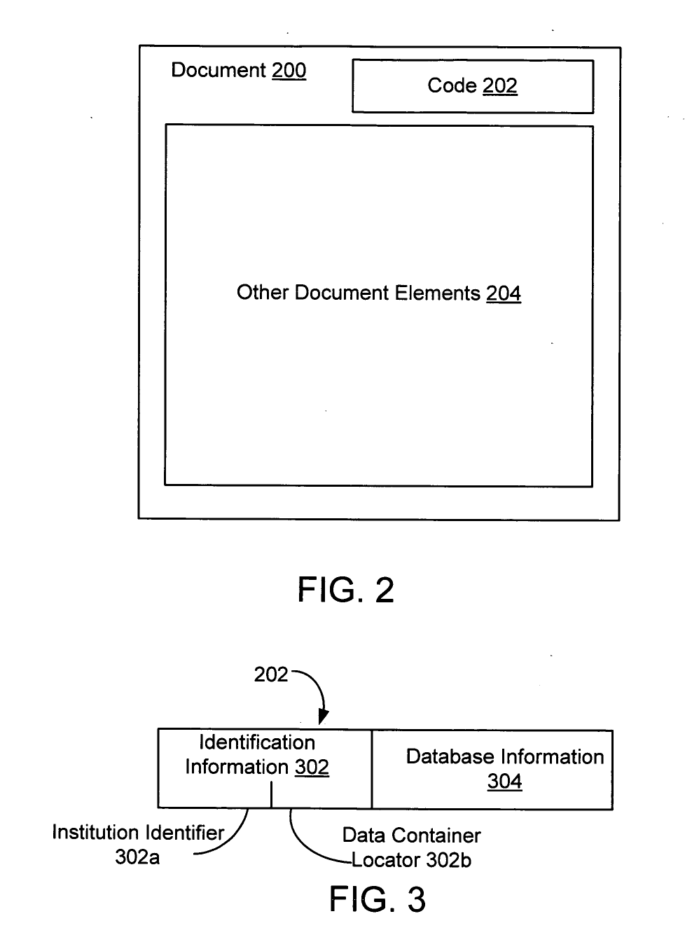

In an embodiment, each data structure stores at least one piece of, some of, or all of the information that is customarily considered to be sufficient, legally required, industry required, and/or required by a particular institution for authenticating a document. The information related to the documents may be indexed according to one or more indices that are independent of the information on the document. For example, the information in the document may be indexed according to memory address locations and/or the order in which the database data structures are created. The key may be a combination of identifiers (e.g., fields). For example, the key may be the combination of an identifier of a storage medium and an identifier of a location on the storage medium. As part of the same example, the data structures may form a data container that has a column for a section identifier, a column for a location within the section, and other columns. The combination of a value from the section identifier column and a value from the location within the section column may uniquely identify a data structure. This example of a key will be returned to while discussing FIG. 3.

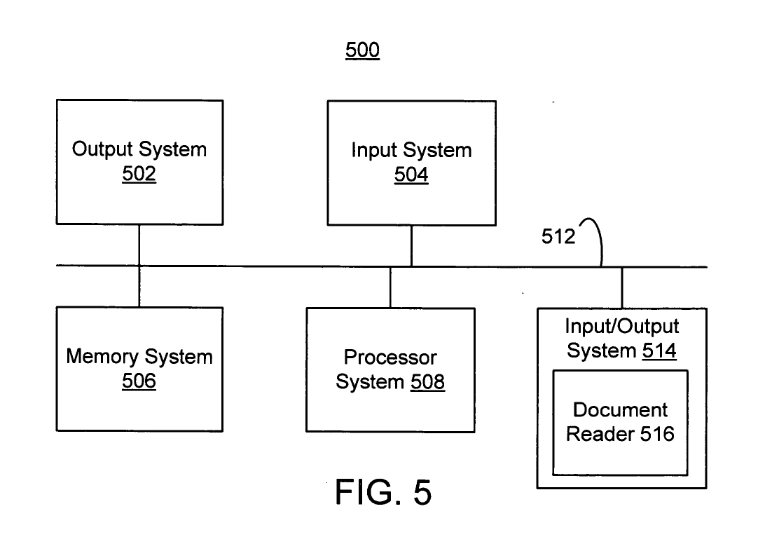

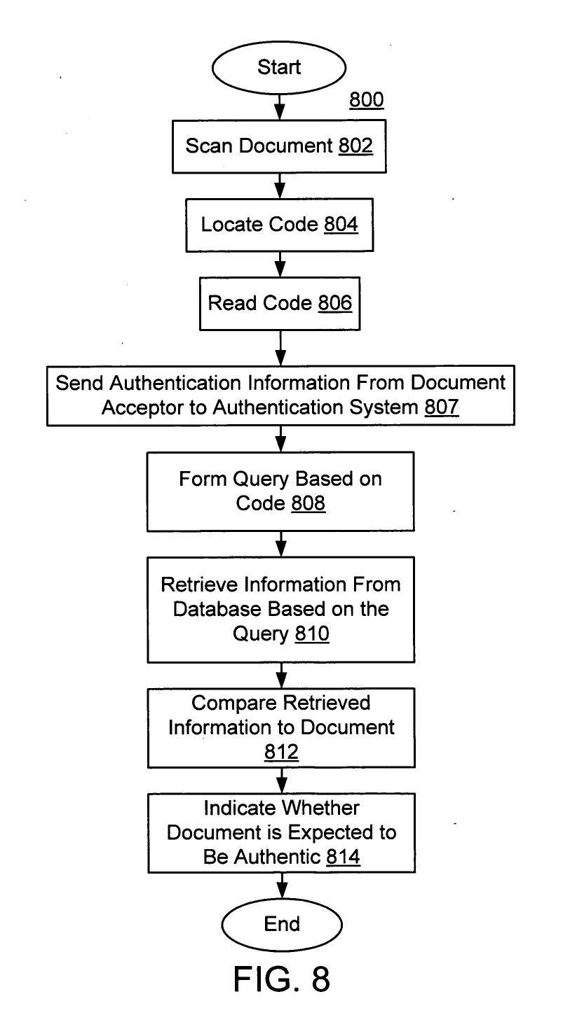

The information stored in database 104 or another database may be found on the front and/or back face of the document issued by issuing institution 102 and/or may include other information related to the document. The data structure associated with a particular document may include location information, such as where information about a client (e.g., a client associated with the document) can be found. For example, the location information may specify a location in another file, data container, and/or database where more information may be found. Optionally, database 104 may also store other information, such as information about documents presented to issuing institution 102 and/or other information about documents issued by other institutions. Database 104 may be maintained by an outside company other than issuing institution 102. For example, if issuing institution 102 is a bank, database 104 may be maintained by a credit bureau and/or another institution unrelated to the credit bureau or bank. In an embodiment, each institution of system 100 may maintain its own database. Some examples of embodiments of database 104 are discussed further in conjunction with FIGS. 5 and 7.

Machine 105 may be used for sending and receiving messages to and from other institutions, creating codes for documents, reading codes on documents, placing the codes on documents and/or document images, and/or storing information associated with (e.g., about, related to, contained within) the documents in a manner such that the code created and/or read may be used to locate the information stored. In this specification the word code refers to any string or pattern of characters and/or shapes that convey information other than an aesthetic appearance. In other words, a pattern that contains no other information other than its aesthetic appearance is not a code, but a pattern or string of characters that carries information whether or not it has other aesthetic features is a code. For example, a pattern of dots, bars or characters is a code, but a picture is not a code unless other information is encoded therein in addition to the image conveyed. One example of a code that may be created by machine 105 is a barcode. In this specification, a barcode (which may also be referred to as a bar code) is a machine-readable representation of information in a visual format on a surface or in an image of a surface.

One type of barcode that may be created and/or read by machine 105 stores data in parallel lines or bars. The information in the barcode may be stored in the distances between the beginnings of two adjacent bars and/or the distances between the ends of two adjacent bars printed parallel lines. Alternatively, the information may be stored in the widths of bars and/or the spaces between bars. However, there are many types of barcodes that may be created and/or formed by machine 150.

In an embodiment, barcodes read and/or created by machine 105 may be a matrix of code (which is a type of two dimensional barcode) that does not consist of bars but rather a grid of square cells or cells of another geometry, such as a grid of rectangles, triangles, and/or hexagons. Each cell may contain one or more geometric shapes. Thus, depending on the embodiment, a barcode produced by machine 105 may be one or more patterns of dots, rectangles, concentric circles, and/or other geometric shapes, which may be hidden in images. In an embodiment, machine 105 may create and/or read barcodes formed by taking barcodes of parallel bars and placing them in multiple rows. Each row, however, is encoded in the same manner as a barcode formed by single row of parallel bars. A barcode formed from rows of parallel bars placed one on top of another may be referred to as a stacked barcode.

In one embodiment, the barcode encoding schemes that may be created and/or read by machine 105 represent just numbers. In another embodiment, other types of characters may be represented, such as characters from the upper case alphabet, the complete ASCII character set, and/or other symbols may be read and/or created by machine 105.

Barcodes can be read by optical scanners called barcode readers or scanned from an image by special software, for example, which may be included within machine 105. Barcodes may be used to implement Auto Identification (ID) Data Capture (AIDC) systems that improve the speed and accuracy of computer data entry.

Machine 105 may receive a request for information about documents stored in database 104. Machine 105 may request information from database 104, and send the results of retrieving information from database 104 to the institution making the request. Machine 105 may interface with database 104, and/or may be database 104. A database management system may be contained within machine 105 and/or database 104. The requests received or sent by machine 105 may include information for locating a data structure in a database (data structure location information, which will be written as data-structure-location-information), which may include a code having an index that identifies a location within a database (such as database 104 and/or another database such as a database within a database institution) and other information for identifying the database in which the data structure is found. In this specification, the term database institution refers to any institution that includes a database that services at least one other institution. Machine 105 may include one machine or several machines, which in turn may include one or more printers, one or more photocopiers, one or more scanners, and/or one or more computers. Machine 105 is discussed further in conjunction with FIGS. 5-7.

Network 106 may be any combination of one or more Wide Area Networks (WANs), one or more Local Area Networks (LANs), one or more wireless networks, and/or one or more phone networks, for example. Messages may be sent via network 106 from other sites to issuing institution 102 and/or from issuing institution 102 to other sites. Network 106 may be used for sending messages related to obtaining information associated with documents, and/or authenticating documents, issued by issuing institution 102. Issuing institution 102 may receive requests (e.g., including data-structure-location-information) via network 106 for information about a document within database 104. In response to the requests, institution 102 may send information about a document issued by issuing institution 102 from database 104 via network 106. Issuing institution 102 may also send requests, including data-structure-location-information, for information and receive information about documents from databases located at other sites.

Other institutions 108a-n may be other entities that are members of system 100 located at sites that are different form issuing institution 102. The ellipses between other institution 108b and other institution 108n indicates that there may be any number of other institutions (including zero) in addition to other institutions 108a, 108b, . . . and 108n. Other institutions 108a-n may need to obtain information associated with, or to authenticate, a document issued by issuing institution 102. One of other institutions 108a-n may send a request via network 106 to issuing institution 102 for information about a document issued by issuing institution 102. Similarly, one of other institutions 108a-n may receive a request via network 106 from issuing institution 102 about a document issued by issuing institution 102. One or more of other institutions 108a-n may be no different than issuing institution 102, except that other institutions 108a-n has currently been presented with a document issued by issuing institution 102, but should issuing institution 102 be presented with a document issued by one of other institutions 108a-n, that one of other institutions 108a-n and issuing institution 102 switch roles. There may be different types of institutions included within other institutions 110a-n, and the specific types may depend on the type of documents involved. For example, if the documents are drivers licenses, institutions 110a-n, may include different drivers, state governments, different parts of state governments, different countries, different parts of governments of countries, different police forces, different motor vehicle agencies, different security agencies, and/or other organizations that use driver's licenses to identify people (and issuing institution 102 may be a motor vehicle administration). In contrast, if the document is a check, other institutions 108a-n may include different payers, payees, check accepting institutions, and check authentication institutions (and issuing institution 102 may be a bank or a payer), for example.

Databases 110a-n are optional and may be associated with other institutions 108a-n, respectively. If none of other institutions 108a-n issue documents that are presented to outside institutions or if database 104 stores information for multiple institutions including at least other institutions 108a-n, for example, then databases 110a-n are not necessary. Databases 110a-n may be the same as or essentially the same as database 104 except databases 110a-n are associated with other institutions 108a-n and database 104 is associated with issuing institution 102. Consequently, some examples of embodiments of databases 110a-n are discussed further in conjunction with FIGS. 5 and 7.

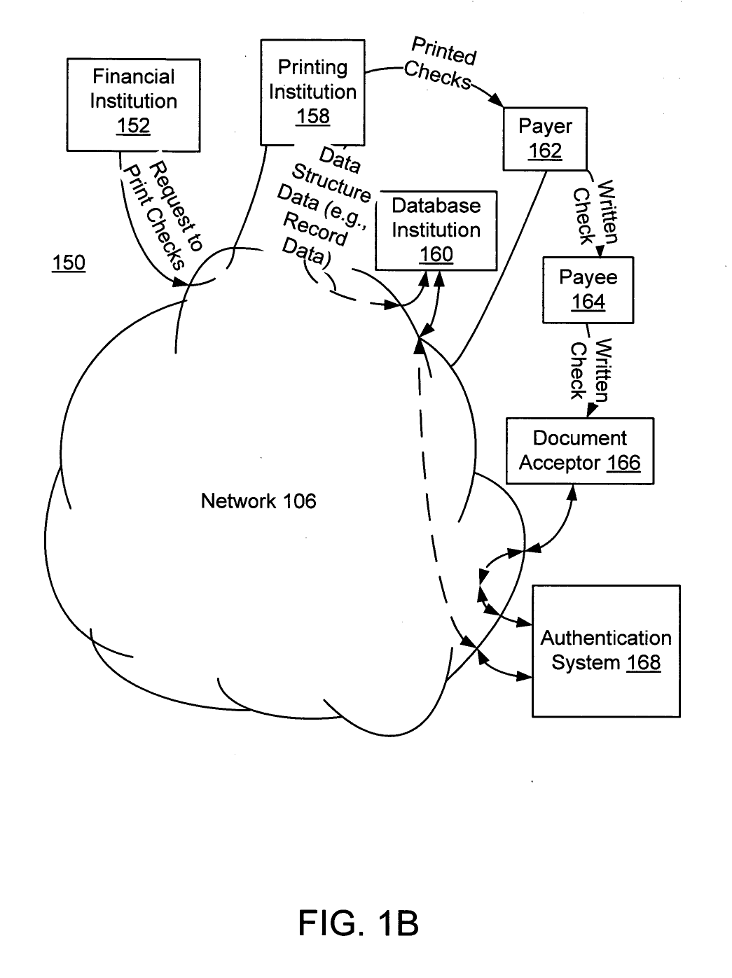

Document 112 may be a document presented at one of other institutions 108a-n. Document 112 may be one of the documents issued by issuing institution 102. Document 112 may have information encoded within (e.g., data-structure-location-information) that may be used to locate information about document 112 within database 104, 110a-n, and/or another database and thereby authenticate document 112. Document 112 may be printed by issuing institution 102, may be printed by a different institution than issuing institution 102, or a private individual, for example. An institution that specializes in printing documents may print document 112. Document 112 may include one or more elements that may be used for authenticating document 112. Information that may be used for authenticating document 112 is discussed further in conjunction with FIGS. 2-4. Information printed on document 112 during printing or added to document 112 after printing, such as during issuance or after issuance, may be placed into a data structure of database 104, 110a-n, and/or another database, and then used to authenticate document 112.

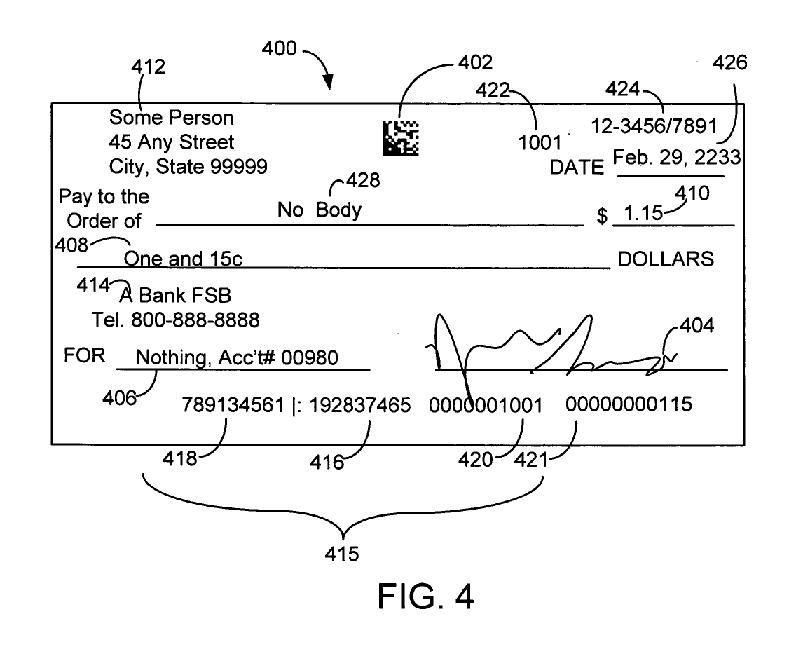

When document 112 is created a data structure for document 112 may be created in database 104, 110a-n, and/or another database, and filled with data that may later be used for authentication. Database 104, 110a-n, and/or another database may contain values that can be derived from document 112, but not actually found within document 112. For example, information within document 112 may be hashed, and the hashed values of specific elements of document 112 may be stored in database 104, 110a-n, and/or another database and used to authenticate document 112. Similarly, features of a signature may be extracted from an image of a signature, stored in database 104, 110a-n, and/or another database, and used to authenticate document 112. Data in document 112 may be stored in encrypted form in a data structure of database 104, 110a-n and/or another database. Later, the encrypted information may be decrypted and compared against authentication data by another party that has access to a decryption key that is used to decrypt the authentication data within database 104, 110a-n, and/or another database. Document 112 is discussed further in conjunction with FIGS. 2-4. An example in which document 112 is a check is discussed in conjunction with FIG. 4.

Document image 113 is an image of document 112. Document image 113 may be obtained by scanning document 112 at one of other institutions 108a-n, for example. Storing document image 113 in addition to, or instead of, storing document 112 may facilitate automating the authentication of document 112 and the storing of information associated with document 112 in database 104, 110a-n, and/or another database. Document image 113 may be used as a representation of the document. One or more of other institutions 108a-n may store document image 113 as a data structure of and/or as a representation of document 112. Document 112 may be destroyed, returned to issuing institution 102, and/or a client of issuing institution 102. Consequently, instead of storing document 112, document image 113 may be stored at issuing institution 102, one or more of other institutions 108a-n, and/or another database, for example.

Machines 114a-n may be used for sending and receiving messages to and from sites outside of other institutions 108a-n, respectively. One of machines 114a-n may receive a request for information about documents stored in 110a-n one of databases 110a-n. Machines 114a-n may request information from databases 110a-n, and send the results of retrieving information from databases 110a-n, respectively, to the institution making the request. Machines 114a-n may interface with databases 110a-n, and/or may be databases 110a-n, respectively. In an embodiment, machines 114a-n may be the same as machine 105 except machines 114a-n are located at other institutions 108a-n and perform functions on behalf of other institutions 108a-n, whereas machine 105 is located at issuing institution 102 and performs function on behalf of issuing institution 102. Further embodiments of machines 114a-n are discussed in conjunction with FIGS. 5-7.

Database 116 is optional and may not be associated with any one institution. Database 116 may service several institutions, and may be part of a database institution that maintains their own databases on behalf of other institutions. In one embodiment, all institutions use database 116, and none of the institutions have their own databases that are part of system 100, in which case databases 104 and 110a-n are not necessary. In another embodiment, some of institutions store information in database 116, in addition to, or instead of, maintaining their own databases for storing information associated with the documents that they issue and/or print. In another embodiment, information about each document can be found in at least one database, which may or may not be located at the site where the document was issued or at the site of a central database. Specifically, each issuing institution 102 may decide whether to maintain its own database 104, use the database at another site, such as one of other institutions 108a-n (e.g., one of databases 110a-n), and/or use a central database, such as database 116. Some institutions may store information in multiple databases associated with the documents that issued from those institutions. One or more of the multiple databases may be maintained by the issuing institution, one or more of the multiple databases may be maintained by another institution, and/or one or more of the multiple databases may be central databases. In another embodiment, each issuing institution stores data about the documents it issues. When an institution (e.g., one of other institutions 108a-n) wants information associated with document 112, the institution that keeps a database including authentication information about the document (e.g., database 116 or issuing institution 102) is contacted. Some examples of embodiments of database 116 are discussed further in conjunction with FIGS. 5 and 7.

Machine 118 may be used for sending and receiving messages to and from any institution. Machine 118 may receive a request for information about documents stored in database 116. Machine 118 may request information from database 116, and send the results of retrieving information from database 116 to the institution making the request. Machine 118 may interface with database 116, and/or may be database 116. In an embodiment, machine 118 may be the same as machine 105 except machine 118 is located at a remote location and performs functions that relate to accessing data in database 116 (if present), whereas machine 105 is located at issuing institution 102 and performs functions on behalf of institution 102. Further embodiments of machine 118 discussed in conjunction with FIGS. 5-7.

Although only one issuing institute, and one document, one document image are shown in FIG. 1A, system 100 may have any number of documents, sites, institutions, databases, machines, and/or other entities that request information associated with documents, issue documents, and/or have databases storing information associated with documents.

FIG. 1B shows system 150, which may be an embodiment of system 100 of FIG. 1A. System 150 may include financial institution 152, printing institution 156, database institution 160, payer 162, payee 164, check acceptor 166, and/or authentication system 168. In other embodiments, system 150 may not have all of the components listed above and/or may have other components in addition to, or instead of, those listed above.

System 150 is an example of system 100 in which document 112 is a check (FIG. 1A). FIG. 1B shows an example of the life of the check. Financial institution 152 may be a bank, savings and loan, stock broker or other financial institution that has one or more account holders that use checks to convey money to a payee. Financial institution 152 is an example of issuing institution 102, and therefore may include database 104 and machine 105 (FIG. 1A). Financial institution 152 sends information about account holders to a printing institution so that the printing institution can print checks.

Financial institution 152 may store information about its account holders in database 104 (FIG. 1A), which is associated with financial institution 152. Database 104 may be maintained by financial institution 152 or another institution and may be located within financial institution 152 or at a remote location.

Printing institution 156 may print checks for one or more financial institutions. Printing institution 156 may receive a request to print checks from financial institution 152. The request to print checks may include information about the accounts and account holders associated with the checks. Alternatively, printing institution 156 may request information about the account holders after receiving the request to print checks, but before printing the checks. In an embodiment, the request to print checks may originate from an account holder of financial institution 152, may include the information needed for printing the check, and printing institution 156 may in response contact financial institution 152 to verify the authenticity of the information provided by the account holder.

Printing institution 156 may create a code (e.g., a barcode) for the checks, print the checks, and print the code on the check while or after printing the check. Printing institution 156 may send data that is intended to be stored in a data structure of a database (which may be referred to as data structure information) to a database institution. The data structure information may include data associated with each check printed and/or that is scheduled to be printed, such as information printed on the check, information associated with financial institution 152, and/or information associated with the account holder. At the database institution, a data structure is added to the database institution for each check. In an embodiment, printing institution 156 creates an index value, which is used by a database institution to index the data structure where the data structure will be located and which is used as at least part of the code created by printing institution 156.

In an alternative embodiment, printing institution 156 may receive information regarding the location of the newly created data structure where the data structure information was stored. The code created via by printing institution 156 may be based at least in part upon the data-structure-location-information received from the database institution.

In an embodiment, for some account holders and/or financial institutions, printing institution 156 may only create the code, but may not actually print the checks. Instead, the code is sent to financial institution 152 and/or an account holder of financial institution 152, which may print their own checks using the code received. In an alternative embodiment, there may be a code creation institution instead of or in addition to printing institution 156. Printing institution 156 may be one of other institutions 108a-n, and therefore may include the corresponding one of databases 110a-n and machines 114a-n (FIG. 1A).

Database institution 160 may receive data for each check printed, which is entered into a data structure of a database in association with the code created by printing institution 156. In an embodiment, database institution 160 indexes the data structure created with an index value created by printing institution 156, and the index value is used to locate the data structure created. Optionally, database system 160 creates the index value and sends the index value or information that can be used to compute the index value to printing institution 156, which uses the index value to create a code. For example, information about the database system at database institution 156 and/or information related to where the next data structure will be stored may be sent to printing institution 156, so that the code having the data structure location data may be created at printing institution 156. The database within which the data structure is created is associated with database institution 160. At a later time, the information stored at database institution 160 may be used to authenticate checks printed by printing institution 158. Database institution 160 may include database 116 and machine 118 (FIG. 1A).

Payer 162 uses checks printed by printing institution 160 for transferring money to a payee by writing a check. Payer 162 receives checks from printing institution 160. Upon writing a check, payer 162 may send information to database institution 160 to update the data structure associated with the check being written. For example, check payer 162 may send the amount of the check, the date, the name of the payee, and/or information associated with a comment portion on the check. The update information may include only information found on the front and/or back of the check and/or may include information not found on the check. Payer 162 may be an individual and/or may be one of other institutions 108a-n (FIG. 1A).

Payee 164 may receive the check written by payer 162, and may present the check to a check acceptor. Optionally, payee 164 may attempt to authenticate the check using one or more institutions that authenticate checks or may collect information that may be used for authenticating the check. For example, payee 164 may request information not on the check, such as information on a driver's license, credit card, debit card, Automated Teller Machine (ATM) card, social security card, and/or passport, from payer 162 to facilitate authenticating the check. Payee 164 may be an account holder of financial institution 152, another financial institution, and/or may be a financial institution. Alternatively, payee 164 may not be an account holder of any financial institution and may not be a financial institution either. Payee 164 may present the check, with authentication information received from payer 162, to a check acceptor. Payee 164 may also give information authenticating (e.g., identifying) payee 164 (e.g., information associated with a driver's license, credit card, debit card, Automated Teller Machine (ATM) card, social security card, and/or passport) to the check acceptor. Payee 164 may be an individual and/or one of other institutions 108a-n (FIG. 1A).

Check acceptor 166 may accept the check from payee 164. Check acceptor 166 may be a bank, credit union, savings and loan, a securities firm, and/or another financial institution at which payer 162 and/or payee 164 holds an account. Check acceptor 166 may be a merchant such as a store, a check cashing service, or another institution that accepts checks. Check acceptor 166 may request other information not found on the check from payee 164. The other information may be associated with the payer 162 and/or payee 164, for example. Check acceptor 166 may send information associated with the check and data-structure-location-information to one or more institutions that authenticate checks or that authenticate one or more parts of the checks (e.g., as part of authenticating the entire check). Based on the results of the authentication, check acceptorl66 may cause money to be transferred (e.g., from financial institution 152) to payee 164, an account associated with payee 164 at check acceptor 166, or another institution. After the money has been transferred, the database data structure at database institution 160 may be updated to indicate that the check was honored. Check acceptor 166 may be one of other institutions 108a-n (FIG. 1A).

Authentication system 168 is a system of one or more institutions that authenticate checks. One or more institutions within authentication system 168 may receive information associated with the check directly from check acceptor 166. Some institutions within authentication system 168 may receive information associated with the check from other institutions within check authentication system 168. Authentication system 168 may request information from database institution 160 associated with the check. The request may include the code placed on the check via printing institution 156 and optionally other data-structure-location-information that is used to locate the data structure within a database associated with the check. Based on the data-structure-location-information, database institution 160 accesses a database data structure associated with the check, and sends information about the check to authentication system 168. Authentication system 168 then compares the information from the database to the information on the check. Authentication system 168 may optionally also compare information from the database to information associated with payer 162 and/or payee 164. Based on the comparison a determination is made by authentication system 168 whether the check is expected to be authentic and/or whether to honor the check. The results of the determination are then sent to check acceptor 166. Authentication system 168 may include one or more of other institutions 108a-n (FIG. 1A).

In an embodiment, financial institution 152, printing institution 156, database institution 160, payer 162, payee 164, check acceptor 166, and/or authentication system 168 may be different roles that the same institution may perform at different times at least for different checks. However, it may be possible to maintain better security by keeping certain roles separate. For example, if printer institution 156 and acceptor 166 are the same, then after a check is presented to acceptor 166, acceptor 166 could add a database data structure to database institution 160 that corresponds to the check presented prior to submitting the check to authentication system 168, which could lead to the payment of invalid checks. Similarly, keeping payer 162 and/or payee 164 different from database institution 160, check acceptor 166, and/or authentication system 168 enhances security by preventing payer 162 and/or payee 164 from having input as whether the check is honored despite the check not fully meeting the criterion that are used to determine whether the check is expected to be authentic.

In an embodiment, a particular institution may perform all roles, but not for the same check. In another embodiment, even for different checks certain roles may not be performed for the same institution as a safeguard against those roles being performed for the same check for those institutions. In yet another embodiment, different institutions may have different security ratings assigned to them indicating the degree to which that institution is trusted, and certain roles are allowed to be performed by the same institution only if that institutions security rating is above (or below) a certain threshold, therein indicating a high enough level of trust.

In still another embodiment, one or more institution's participating in the circulation of a particular check in question may determine which roles may be performed by the same institution, and consequently which institutions are allowed to perform which roles and which roles are allowed to be performed by the same institution may be different depending on the particular institutions involved in circulating a particular check. For example, payer 162 and payee 164 may be individual people and may both hold accounts in financial institution 152. After receiving the check from payer 162, payee 164 may present the check to financial institution 152, making financial institution 152 into check acceptor 166. Additionally, especially while system 150 is first beginning to be introduced to a particular financial market, financial institution 152 may also perform the roles of printing institution 158 and database institution 160, because as of yet, no other printing institutions or database institution handles the code (having data-structure-location-information) printed on the check. As long as payer 162 and payee 164 trust financial institution 152, there may be no problem with the transaction even though printing institution 156 is check acceptor 166, as long as financial institution 152 trusts itself to also perform the roles of both printing institution 156 and check acceptor 166.

Although system 150 was described using a check, a similar system may be used for any type of document. For example, financial institution 152 may be replaced with any institution that holds the account of one of the parties associated with (e.g., that at least initially holds or owns) the document, payer 162 and payee 164 may be replaced with any two parties affected by the document, and check acceptor 166 may be replaced with a document acceptor.

FIG. 2 shows a document 200 having a code 202 and other document elements 204. In other embodiments, document 200 may not have all of the components listed above and/or may have other components in addition to, or instead of, those listed above.

Document 200 may be any document or document image. Document 200 may be an embodiment of document 112 or an embodiment of document image 113 of FIG. 1A. In an embodiment, document 200 is a check. In another embodiment, document 200 is another type of document, such as a stock certificate, a deed (e.g., a deed to a car or a house), a contract, a school transcript, or another document.

Code 202 may be included on document 200. Encoded within code 202 may be at least some data-structure-location-information, such as index information and/or data structure information used for locating the information about the document 200 in database 104, 110a-n, 116 and/or another database (FIG. 1A) such as a database associated with database institution 160 (FIG. 1B), that may be otherwise uncorrelated to the information (e.g., document identifiers) in document 200. The index information within code 202 may include a database key for locating a database data structure.

Code 202 may be a barcode or another code, such as a string of alphanumeric characters, or another pattern that encodes information. For example, a string of different symbols may be used instead of a barcode. Code 202 may contain one or more identifiers associated with document 200. Code 202 may be placed on the front of document 200. Alternatively, instead of or in addition to placing code 202 on the front of document 200, code 202 may be placed on the back of document 200. In an embodiment, there may be multiple codes (that are of the same type as code 202) on document 200.

At the time document 200 is presented to one of other institutions 108a-n, other institutions 108a-n may obtain data-structure-location-information at least in part from code 202, and may send the data-structure-location-information to machine 114a-n (FIG. 1A). Using the data-structure-location-information from code 202 (and possibly other data-structure-location-information), machine 118 locates information related to document 200 in database 116 (FIG. 1A). The information found in database 116 is then sent back to the one of other institutions 108a-n that made the request, and the one of other institutions 108a-n that made the request uses the information from database 116 (FIG. 1A) to authenticate document 200 (which may be a document or a document image). Authentication rules can be based on any combination of data in the database that is referenced by code 202 and/or document 200.

Authentication information may be placed in separate fields and/or columns of one or more of databases 104, 110a-n, 116, and/or another database, and consequently may be used separately for authenticating a document (FIG. 1A). The information in one or more of databases 104, 110a-n, 116, and/or another database may be updated, revised, and the entire system may be updated by adding new columns and/or fields and/or by adding new information to existing columns/fields of one or more of databases 104, 110a-n, 116, and/or another database without affecting the ability of an institution to authenticate documents. In an embodiment, code 202 only includes data-structure-location-information (e.g., an index value) that locates one of databases 104, 110a-n, 116, and/or another database, and locates a data structure within one or databases 104, 110a-n, and 116. Since code 202 stores data-structure-location-information (as opposed to identification information) authentication data may be added to one or more of databases 104, 110a-n, 116, and/or another database at any time, thus giving ability to extend the authentication data beyond data available at the time of printing, issuing document 200, and/or at another time.

Since code 202 includes data-structure-location-information instead of authentication information, as long as the security of the one or more of databases 104, 110a-n, 116, and/or another database (FIG. 1A) (where the authentication information is stored) is maintained, a forger will be hampered from identifying an index that will pass the authentication process. Since the data-structure-location-information in code 202 is not useful without access to at least one of databases 104, 110a-n, 116, and/or another database, as long as access to those of databases 104, 110a-n, 116, and/or another database that store authentication information is restricted to only trustworthy users, there is no need to encrypt the data structure location data in code 202 (for example, there may be no need to encrypt any of code 202), which may allow code 202 to be smaller than were all of code 202 encrypted. Consequently, in one embodiment code 202 is encrypted, in another embodiment code 202 is partially encrypted, and in another embodiment code 202 is not encrypted.

Using a binary encoding for code 202, an 80 bit identifier allows the identification of approximately 1.21×10²⁴ documents (e.g., less than 1.22×10²⁴, the approximation is in the approximate conversion of a binary number to a base ten number). Since there are so many possibilities for the value of the data-structure-location-information (e.g., the value of a data structure location identifier such as an index) included in code 202, the probability is relatively low of a collision (the issuing of two data structure location identifiers with same value that are later confused with one another). The data structure location identifiers used for codes 202 can be allowed to be duplicated since the probability is very low that there exist two data structure location identifiers that match one another for two uncorrelated sets of documents. Consequently, the number of bits used for code 202 may be relatively low, e.g., less than 80 bits. Code 202 may contain 24 bits which allows the location of approximately 2.8×10¹⁴ documents (within the approximation of converting a binary number to a base ten number). Code 202 will be discussed further in conjunction with FIGS. 3 and 4.

Other document elements 204 may include all other elements of a document. Other document elements 204 may include authentication features, security features (which may also be called authentication features), data structure location features (features containing data-structure-location-information), and/or any other document elements. In this specification authentication features are generic to security features. Security features are features that are present primarily to add security, while authentication features are any feature that may be used to authenticate a document whether or not the feature's primary purpose is for providing security. In any place in this specification the terms security feature, authentication features and their equivalents may be substituted one for another, which may result in different embodiments. In some cases the same document element may be used as an authentication feature and a data structure location features.

To facilitate an authentication process of document 112, it may be desirable that document 112 have at least one or more elements that include one or more security features that are transferred to document image 113 while creating document image 113, such as during the scanning process (FIG. 1A). In an embodiment, other document elements 204 may include one or more of the security features that are of a substantially minimum size while still being easily legible, legible, or barely legible (e.g., close enough to the minimum size such that the differences in size and/or legibility are not noticeable to an average human being). By keeping the size of the security feature relatively small there is more room for including other features or writing other things on document 200. The space on the front side of document 200 and even the space available on the back side of document 200 may be at least somewhat limited. In an embodiment, the security features are expected to be difficult to forge. Specifically, it may be desirable to place one or more security features on document 200 that are expected to be difficult to duplicate on a forged version of document 200. In an embodiment, the writer or issuer of document 200 is given the flexibility of selecting a set of authentication features that may be used to confirm the validity of document 200. In an embodiment, code 202 is used as a security feature. Code 202 may be difficult to forge, because at least part of code 202 may be uncorrelated with other document elements 204 and document 200 other than code 202 identifying the location of a data structure that stores information about document 200 and/or document elements 204. Consequently the probability of guessing a valid value for code 202 may be relatively low, and the probability of guessing a valid value for code 202 that also identifies the data structure with the correct authentication information is even lower. In other embodiments, code 202 is a convenience that facilitates accessing certain types of information associated with document 200.

Optionally, authentication data, which may be associated with one or more security features, and/or other data may also be extracted from document 200. Together the data that was extracted and code 202 may be sent (e.g., via network 106) to an authenticator, such as authentication system 168, for authenticating document 200. In an embodiment, in addition to, or instead of, having document identification in code 202, a document identifier may be placed on document 200 in other document elements 204 in human readable form. After a human reads the document identification, the document identification may be keyed into one of databases 104, 110a-n, 116, and/or another database if a machine readable identifier is not present or cannot be machine-read (FIG. 1A). The document identifier that was keyed in may then be used to create code 202, which is then placed on document image 113 (FIG. 1A). In an embodiment, instead of or in addition to including a machine readable identifier within code 202 on document 200, an identifier may be included in other document elements 204 in OCR-readable form.

FIG. 3 shows an embodiment of code 202 of FIG. 2, which has identification information 302 and database information 304. Identification information 302 may include a data container locator 302b and an institution identifier 302a. In other embodiments, code 202 may not have all of the components listed above and/or may have other components in addition to, or instead of, those listed above.

Identification information 302 may identify the institution that issued document 200 (FIG. 2). Identification information 302 may be contained within a data container portion of code 202, which may contain information about an identity of an institution having a database where information about document 200 may be found. Data container locator 302b may point to a database or a data container within a database where the data structure may be found. Institution identifier 302a identifies the institution where the database having the data structure is located. Institution identifier 302a may also identify a branch and/or section of an institution associated with document 200. In an embodiment, data container locator 302b does not identify a document. Data container locator 302b may point to a client, an account, a group of accounts, and/or a group of documents (e.g., documents belonging to the same batch or run).

Database information 304 may be an identifier of a data structure such as an index within a database that contains information about document 200 (FIG. 2). Database information may be contained within a database portion of code 202, which may include information related to locating a data structure within a database.

Database information 304 may include a key, which uniquely identifies a data structure (such as a row) within a data container (such as a table) of a database 110a-n. For example, the key may be just one field (e.g., a column) that alone uniquely identifies a data structure and is uncorrelated outside the database to the document. As another example, each data structure may have at least three fields (e.g. columns), for example, in which at least one is a content field, which includes at least some information about contents of document 200 (FIG. 2) and/or other information. The record may also have at least two other fields that together (but not separately) uniquely determine a particular record and therefore form a key, but which are not correlated to the identification of document 200 except internally within the data container within the database that contains the record. As an example using relational databases, it may be that the first of two columns that form the key has multiple rows with the same value, but that nonetheless correspond to different records. Similarly, that the second of two columns that form the key also has multiple rows with the same value, but that nonetheless correspond to different records. However, the combination each of the columns that form the key 110a-n may be used to uniquely identify document 200 (in a database, a key is a combination of columns that uniquely identifies a record).

Alternatively, a single column and/or a combination of columns that does not necessarily uniquely identify a data structure may be used to identify a data structure if the probability of a collision is low enough so that if there is a collision, there will most likely only be a small enough number of data structures to check that it is still practical to see if the document 200 (FIG. 2) matches any of the documents found in database 104, 110a-n, 116, and/or another database (FIG. 1A) (such as a database associated with database institution 160 of FIG. 1B) without keeping the requestor of information waiting for a period of time that is longer than it is expected the requestor would be willing to wait (e.g., no longer than a few seconds). The probability of collisions may be set low enough so that the maximum number of data structures that are expected to be likely to be found is small enough and/or the likelihood of finding more than one data structure is small enough so that a random choice of an index value is expected to be unlikely to find a document to which the forged document corresponds allowing the forgery to pass as an authentic document.

Code 202 may have a certain percentage allocated to identifying the institution from which the document was issued and another percentage allocated to identifying the data structure associated with a document within an account. The percentage of code 202 that is used for identification information 302 and the percentage of code 202 that is used for database information 304 may depend on the type institution that is identified. For example, if document 200 (FIG. 2) is a check and if issuing institution 102 (FIG. 1A) is a bank, there are many more credit unions than large banks. Additionally, large banks tend to have more accounts than a credit union. Consequently, a large bank may have a smaller percentage of code 202 that is dedicated to identification information 302 identifying the bank and a larger percentage of code 202 that is dedicated to database information 304 for identifying the data structure in comparison to a credit union. Code 202 may also have a percentage that is dedicated to conveying the type of information contained within code 202.

If document 200 (FIG. 2) has limited space, it may be desirable to keep code 202 small. By storing information identifying the data structure in database information 304 instead of storing the actual information in code 202, code 202 can be much smaller. In an embodiment, outside of databases 104, 110a-n, 116, and/or another database (FIG. 1A) (such as a database associated with database institution 160 of FIG. 1B), the index information within database information 304 has no correlation to authentication data within other document elements 204 (FIG. 2). Code 202 may include a portion that identifies the type of information that can be found in code 202, such as the length of the portion containing database information 304 and the length of the portion containing identifier information. Code 202 may contain in addition to a document identifier, a design identifier that uniquely identifies a barcode in a check authentication environment. The barcode may contain, in addition to a document identifier, data that identifies authentication features that may be extracted from document 200 and sent and used for authentication.

FIG. 4 shows check 400, which is an embodiment of document 200 (of FIG. 2). Check 400 includes barcode 402, signature 404, comments 406, amount 408, amount 410, client information 412, institution information 414, and MICR line 415. MICR line 415 may include account number 416, routing number 418, check number 420, and amount 421. Check 400 may also include check number 422, ABA fraction 424, date 426, and recipient 428. In other embodiments, check 400 may not have all of the components listed above and/or may have other components in addition to, or instead of, those listed above.

Check 400 is as example of document 200 (FIG. 2) and therefore may be an example of document 112 or document image 113 (FIG. 1A). Many financial institutions use the image of the check as a legal representation of the check. Previously, a physical check was stored in the bank and validity of the check could be established by examining the actual check. Alternatively, the original check may have been returned to the check writer and a photocopy of the check was stored at the financial institution. With the advent of check imaging, the physical copy of check 400 might be destroyed after being presented, and converted into an image. Unfortunately, security features present on a printed check or other document, such as watermarks, microprint, and temperature sensitive ink, are necessarily not stored with the image, but lost with the destruction of the original check corresponding to check 400.

Barcode 402 is an example of code 202 (FIG. 2). Signature 404, comments 406, amount 408, amount 410, client information 412, institution information 414, account number 416, routing number 418, check number 420, amount 421, check number 422, ABA fraction 424, date 426, and recipient 428 are examples of other document elements 204 (FIG. 2). Barcode 402, signature 404, comments 406, amount 408, amount 410, client information 412, institution information 414, account number 416, routing number 418, check number 420, amount 421, check number 422, ABA fraction 424, date 426, and recipient 428 are examples of authentication features that may be used to confirm the validity of the check (the amount of the check is included as a authentication feature, because if the check is for the wrong amount it may be an indication that the check is invalid). Institution information 414, routing number 422, and/or ABA fraction 424 may be included within data-structure-location-information along with barcode 402.

In an embodiment, in contrast to watermarks, microprints, and temperature sensitive inks, barcode 402 may be photocopied and/or stored with a physical check, copy of a check, and/or an image associated with check 400. Similarly barcode 402 may be read and/or scanned to determine the location of a data structure in a database that may be used for authenticating information on check 400. Consequently, in an embodiment barcode 402 may be used as a security feature that may be photocopied.

Signature 404 is a signature of someone authorized to write checks, such as a client of the institution that issues check 400. Copies of one or more signatures of the check writer and/or information about or features of signature 404 may be stored at database 104, 110a-n, 116, and/or another database (FIG. 1A) (such as a database associated with database institution 160 of FIG. 1B). Comments 406 may include descriptive information about the type of transaction for which check 400 was written. Amount 408 may include an amount for which the check is worth in a text format. In contrast, amount 410 may contain an amount that the check is worth in a numerical format. Client information 412 may include the name, address, and/or phone number of the client of the institution that issued check 400. Institution information 414 may include the name, address, and/or phone number of the institution that issued check 400. MICR line 415 may be used to identify the institution associated with check 400 (via routing number 418), the account associated with check 400 (via account number 416, the check number (via check number 420) and the amount associated wtih check 400 (via amount 421). Account number 416 may include an account from which the money is taken associated with check 400.

Routing number 418 and ABA fraction 424 may include information identifying the institution and the location of the institution that issued check 400. For example, in the ABA fraction 12-3456/7891, 12 is a city code associated with the institution, 3456 identifies the institution, and 7891 is a Federal Reserve Routing Symbol. Check number 420 and check number 422 may be the same number and may be a sequence number associated with check 400. Amount 421 may be the same as amount 410. Date 426 may the date on which check 400 was written. Recipient 428 may be the party (e.g., person or institution) to which the money associated with check 400 will be transferred. A part of, all of, any one of, or any combination of comments 406, amount 408, amount 410, client information 412, institution information 414, account number 416, routing number 418, check number 420, amount 421, check number 422, ABA fraction 424, date 426, and/or recipient 428 may be used to authenticate check 400.

In an embodiment, a data structure location identifier (having data-structure-location-information) may be created and included within barcode 402. The data structure location identifier may contain data that may be required to find a specific instance of check 400 in one or more of databases 104, 110a-n, 116, and/or another database (FIG. 1A) (such as a database associated with database institution 160 of FIG. 1B). The data structure location identifier may include and/or may assist in locating a data structure number, a key, and/or a check number associated with check 400, for example. The data structure location identifier may be an example of institution identifier 302 (FIG. 3), database information 304 (FIG. 3), and/or code 202 (FIGS. 2 and 3). Barcode 402 may contain binary information and/or alphanumeric information. MICR line 417 may be included within institution identifier 302a and/or data container locator 302b (FIGS. 3).

In an embodiment, barcode 402 is printed on the front of check 400 (as illustrated in FIG. 4). Alternatively, or in addition to, placing barcode 402 on the front of check 400, barcode 402 may be placed on the back of check 400. In an embodiment, there may be multiple barcodes on check 400. At the time check 400 is presented to one of other institutions 108a-n (FIG. 1A), the one of other institutions 108a-n to which check 400 was presented obtains at least some of the data-structure-location-information from barcode 402.

In an embodiment, the check writer (e.g., payee 162 of FIG. 1B), issuer (e.g., issuing institution 102 of FIG. 1A) and/or authenticator (e.g., document authenticator 166 of FIG. 1B) may be able to choose to use the bank routing number and account number for authenticating the check, but not use the amount of the check as a criterion for authenticating the check. The check writer may be able to choose which elements to leave blank and fill in at the time the check is written. It may be desirable to allow the check issuer to choose which features are added after printing check 400. For example when check 400 is issued, the amount and signature of the check become known. Although a security element may be placed on the check at the time of printing, it may be desirable to authenticate that the correct amount is on check 400 at the time check 400 is presented. In an embodiment, some information associated with check 400 may be entered at the time check 400 is printed, and other information, such as the check amount that may not be known until the time at which check 400 issues, may be placed on check 400 and entered into a data structure of one or more of databases 104, 110a-n, 116, and/or another database (FIG. 1A) (such as a database associated with database institution 160 of FIG. 1B) at the time check 400 is issued. Alternatively, all of the information to be recorded is entered into a data structure of one or more of databases 104, 110a-n, 116, and/or another database at the time check 400 is issued. Although check 400 is given as an example of document 200 (FIG. 2), code 202 (FIGS. 2 and 3) (e.g., barcode 402) may be applied to other documents, such as documents in which authentication has to be performed at the time the document is presented.

FIG. 5 shows a block diagram of a machine 500 used in system 100. Machine 500 may include output system 502, input system 504, memory system 506, processor system 508, communications system 512, and input/output device 514. In other embodiments, machine 500 may not have all of the components listed above and/or may have other components in addition to, or instead of, those listed above.

Machine 500 is an example of a machine that may be used for authenticating documents, such as machines 105, 114a-n, and 118. Machine 500 may be used for sending and receiving messages to and from institutions outside of the institution with which machine 500 is associated with. Machine 500 may be and/or may include a computer, printer, copier, and/or scanner.

Output system 502 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example. Output system 502 may be used for creating documents and/or document images. Output system 502 may be used for adding code 202 to a document and/or document image, such as document 200.

Input system 504 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example. The scanner system may include an image scanner, a digital imager, and/or a check transport. Input system 504 may be used for scanning documents that are stored and/or that may need to be authenticated. Input system 504 may be used for reading code 202 (FIGS. 2 and 3). Input system 504 may also be used for adding code 202 to a document and/or document image, such as document 200 (FIG. 2).

Memory system 506 may include, for example, any one of, some of, any combination of, or all of a long term storage system, such as a hard drive; a short term storage system, such as random access memory; a removable storage system, such as a floppy drive or a removable drive; and/or flash memory. Memory system 506 may include one or more machine readable mediums that may store a variety of different types of information. The term machine-readable medium is used to refer to any medium capable carrying information that is readable by a machine. One example of a machine-readable medium is a computer-readable medium. The term machine-readable medium also includes mediums that carry information while the information is in transit from one location to another, such as copper wire and/or optical fiber.

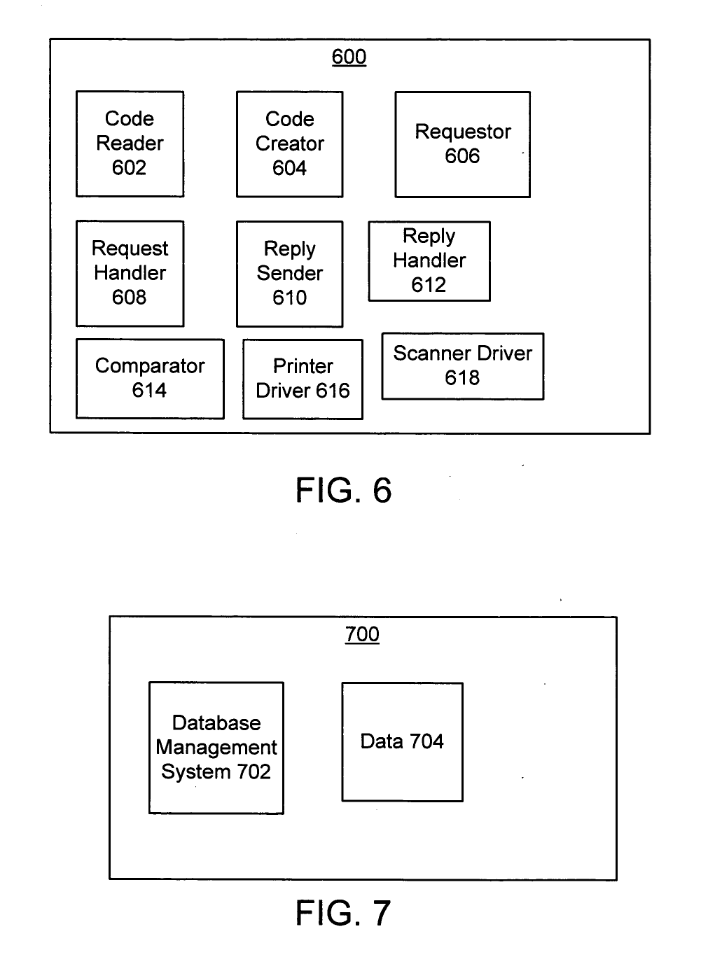

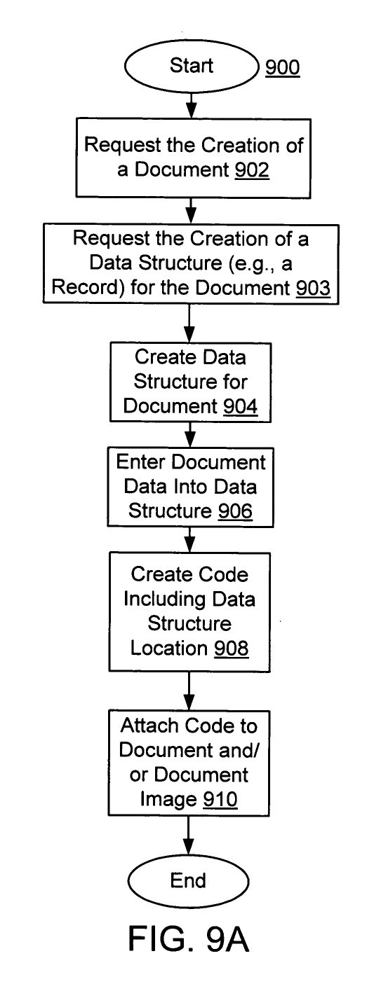

Memory system 506 may store one or more instructions for reading and/or creating codes 202 (FIGS. 2 and 3), such as barcodes. Memory system 506 may include one or more instructions for submitting a request for information about a document based on code 202, for receiving information about document 200 (FIG. 2) in response to a request, and/or for authenticating document 200 based on information stored in database 104, 110a-n, 116, and/or another database (FIG. 1A) (such as a database associated with database institution 160 of FIG. 1B), which was found based on code 202 and other document elements 204 (FIG. 2) on document 200. Memory system 506 may include one or more instructions that constitute a database management system for accessing data in database 104, 110a-n, 116, and/or another database. Memory system 506 may include one or more instructions for carrying out the methods of FIGS. 8-10. Memory 506 will be discussed further in FIGS. 6 and 7.

Processor system 508 may include any one of, some of, any combination of, or all of multiple parallel processors, a single processor, a system of processors having one or more central processors and/or one or more specialized processors dedicated to specific tasks. Processor 508 may carry out the instructions stored in memory system 506.

Communications system 512 communicatively links output system 502, input system 504, memory system 506, processor system 508, and/or input/output system 514 to each other. Communications system 512 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Input/output system 514 may include devices that have the dual function as input and output devices. For example, input/output system 514 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 514 is optional, and may be used in addition to or in place of output system 502 and/or input device 504.

FIG. 6 shows an embodiment of memory system 600, which may include code reader 602, code creator 604, requestor 606, request handler 608, reply sender 610, reply handler 612, comparator 614, printer driver 616, and scanner driver 618. In other embodiments, memory system 600 may not have all of the components listed above and/or may have other components in addition to, or instead of, those listed above.

Memory system 600 is an embodiment of memory system 506 (FIG. 5). Code reader 602 reads codes on documents. Code reader 602 may be part of a scanner driver.

Code creator 604 creates codes, such as code 202 (FIG. 2) or barcode 402 (FIG. 4), which may include data-structure-location-information for one or more of databases 104, 110a-n, 116, and/or another database (FIG. 1A) (such as a database associated with database institution 160 of FIG. 1B), and/or may contain information identifying database institution 160 and/or the location of one or more of databases 104, 110a-n, 116, and/or another database. Code creator 604 may also send a message to one or more of databases 104, 110a-n, 116, and/or another database to data structure information about the document 112 (FIG. 1A), and possibly create a data structure for document 112. Code creator 604 may be part of a printer driver or scanner driver.

Requestor 606 may request information about document 112 (FIG. 1A) based at least in part on the code read by code reader 602. Request handler 608 may handle requests to retrieve information from one of database 104, databases 110a-n, database 116, or database (FIG. 1A). Request handler 608 may be a database management system or may submit a request to a database management system. In submitting the request, the request may be converted into a database language, such as Structured Query Language (SQL). The conversion of the request to the database language may occur in one of many places, such as requestor 606, request handler 608, and/or the database management system.

Reply sender 610 determines the answer to the request and sends the reply back to the sender. Reply sender 610 may be part of the database management system or may be a separate unit that interfaces with the database management system. For example, the database management system may send the answer to the request to reply sender 610, or reply sender 610 retrieves the answer from the database management system.

Reply handler 612 handles replies received from a reply from a sender in another machine. Comparator 614 compares the reply from reply handler 612 to information on document 200 (FIG. 2).

Printer driver 616 may be a software interface between processor system 508 and a printer within output system 502 (FIG. 5). Printer driver 616 includes one or more instructions for controlling a printer. Printer driver 616 may include code creator 604. Scanner driver 618 may be a software interface between processor system 508 and a scanner within input system 504 (FIG. 5). Scanner driver 618 includes one or more instructions for controlling a scanner. Scanner driver 618 may include code reader 602 and/or code creator 604.

Although in the embodiment of FIG. 6, each is a separate program unit, in other embodiments, code reader 602, code creator 604, requestor 606, request handler 608, reply sender 610, reply handler 612, comparator 614, printer driver 616, and scanner driver 618 may not be separate program units. One or more of code reader 602, code creator 604, requestor 606, request handler 608, reply sender 610, reply handler 612, comparator 614, printer driver 616, and/or scanner driver 618 may be one or more instructions that are inter-dispersed within one another. Instead of being instructions stored in memory system 600, one or more of code reader 602, code creator 604, requestor 606, request handler 608, reply sender 610, reply handler 612, comparator 614, printer driver 616, and/or scanner driver 618 may be hardware units. For example, code reader 602 and code creator 604 may be part of a scanner. Also, in another embodiment, code creator 604 may be part of a printer.

FIG. 7 shows an embodiment of memory system 700, which may include database management system 702 and data 704. In other embodiments, memory system 700 may not have all of the components listed above and/or may have other components in addition to, or instead of, those listed above.

Memory system 700 may be an embodiment of memory system 506 (FIG. 5). Memory system 700 may be included in an embodiment of machine 500 (FIG. 5) that is used for any of databases 104, 110a-n, 116, and/or another database (FIG. 1A) (such as a database associated with database institution 160 of FIG. 1B). Database management system 702 may access the database by retrieving information from the database and writing information into the database. Database management system 702 may support a database language, such as SQL. Data 704 may include information about documents, which may be arranged in a relational database, another type of database, or in another fashion.

FIG. 8 shows a flowchart of an embodiment of a method 800 for presenting and authenticating a document. In step 802, document 112 (FIG. 1A) is scanned via scanner driver 618 and a scanner from output system 504 (FIG. 5) at one of other institutions 108a-n (FIG. 1A), such as check acceptor 166 (FIG. 1B). During the scanning, some authentication information and some data-structure-location-information may be determined from other document information 204 (FIG. 2). Document 112 may be a document that is presented to other database 110a-n and issued by issuing database 102 (FIG. 1A). In step 804, the location of code 202 (FIG. 2) on document 112 is determined.

In step 806, code 202 is read. Reading code 202 (FIGS. 2 and 3) may include reading identification information 302 and database information 304 (FIG. 3). Reading identification 302 may include reading institution identifier 302a and data container locator 302b (FIG. 3). Reading identification information 302 may include reading a data container portion that contains an identification and/or a location of an institution associated with the database where the information about document 112 (FIG. 1A) can be found. Steps 804-806 may be performed using code reader 602 (FIG. 6).

In step 807, the data-structure-location-information and the authentication information is sent from a document acceptor, such as check acceptor 166, to authentication system 168 (FIG. 1B). In step 808, a query is formed based on the information in code 202 (FIGS. 2 and 3), which may be performed with the aid of requestor 606 (FIG. 6). The query may be formed at authentication system 168 and sent to database institution 160, or the query may be formed at database institution 160 (FIG. 1B). Step 808 may involve sending the request from a requester (such as requestor 606) at authentication system 168 to a request hander (such as request handler 608) that is located at database institution 160. At database institution 160, a request handler (similar to request handler 608 of FIG. 6, but at database institution 160) may send a query to a database (e.g., associated with database institution 160).

In step 810, information is retrieved from one of databases 104, 110a-n, 116, and/or another database (FIG. 1A) (such as a database associated with database institution 160 of FIG. 1B), such as database institution 160 (FIG. 1B), based on the query. The information may be sent from the one of other institutions 108a-n (FIG. 1A) from which the information was retrieved, such as database institution 160 to authentication system 168 (FIG. 1B). The results of the query are retrieved by a reply sender (e.g., similar to reply sender 610) and sent from database institution 154 (FIG. 1B) back to authentication system 166 (FIG. 1B), where reply handler 612 (FIG. 6) may receive the reply. In step 812, at authentication system 166 (FIG. 1B), the retrieved information may be compared to document 112 (FIG. 1A) using comparator 614 (FIG. 6). In step 814, a decision may be made as to whether document 112 is authentic based on the comparison of step 812, which may also be performed using comparator 614. In step 814, the results of the authentication are sent from authentication system 168 to check acceptor 166.

Any of steps 810-814 may be performed at issuing institution 102, other institutions 108a-n, and/or at a remote site associated with database 116 and machine 118 (FIG. 1A). In an embodiment, each of the steps of method 800 is a distinct step. In another embodiment, although depicted as distinct steps in FIG. 8, step 802-814 may not be distinct steps. In other embodiments, method 800 may not have all of the above steps and/or may have other steps in addition to, or instead of, those listed above. The steps and/or parts of the steps of method 800 may be performed in another order. Subsets of the steps listed above as part of method 800 may be used to form their own method.

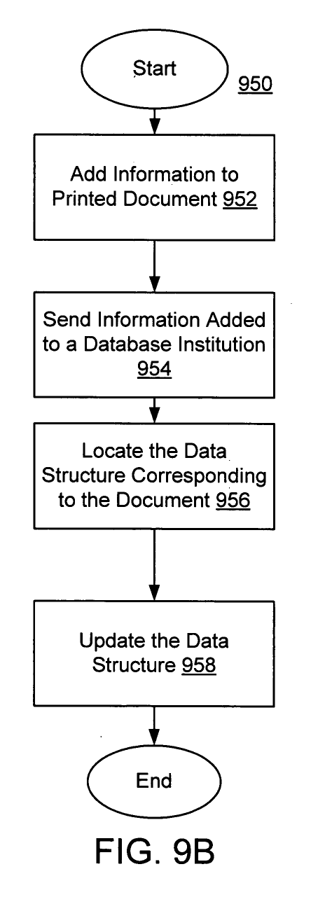

FIG. 9A shows a flowchart of an embodiment of a method 900 for entering a document into system 100. In step 902, a request is made to create a document (document 112 of FIG. 1B). In step 902, the request to create the document and information that may be useful for creating a document may be sent from issuing institution 102 of FIG. 1A (e.g., financial institution 152 or payer 162 of FIG. 1B) to one of other institutions 108a-n of FIG. 1A (e.g., printing institution 156 of FIG. 1B). In step 903, a request is made to create a data structure for the document. In step 903, authentication information along with the request to create the data structure may be sent from the other institution (e.g., printing institution 156) to database 104, 110a-n, 116, and/or another database (FIG. 1A) (such as a database associated with database institution 160 of FIG. 1B). Step 903 may include creating an index (for indexing the newly created document) at the other institution and sending the index to database 104, 110a-n, 116, and/or another database. Alternatively, the creation of the index may have been performed in step 902 or may be performed at the database in a later step. In step 904, a data structure may be created for document 112 in database 104, 110a-n, 116, and/or another database using database management system 702 (FIG. 7). Step 904 may include indexing the newly created data structure at database 104, 110a-n, 116, and/or another database with the index sent from the other institution. In step 906, at least one piece of data from document 112 may be entered into the data structure created for document 112 in one of databases 104, 110a-n, 116, and/or another database (FIG. 1A) (such as a database associated with database institution 160 of FIG. 1B) using database management system 704 (FIG. 7). In step 908, at the other institution (e.g., printing institution 156), code 202 (FIGS. 2 and 3) may be created, using code creator 602 (FIG. 6), including the location of the data structure within one of databases 104, 110a-n, and 116 (FIG. 1A) and an identifier identifying the institution with which the database containing the data structure is associated. The location information may include the index created at the other institution and sent to one of databases 104, 110a-n, and 116 and/or may be location information received from one of databases 104, 110a-n, and 116 about the location of the data structure within that database. Step 908 may also involve determining the type of institution that is associated with the document and/or the type of document, and (based on the type) determining a portion of code 202 that is to be used for database information and a portion that is to be used for institution information. In step 910, code 202 is attached to document 112 and/or a document image 113 (FIG. 1A). Step 910 may include creating document image 113 and/or printing a copy of document 112, either of which may involve printer driver 616 (FIG. 6).

In an embodiment, each of the steps of method 900 is a distinct step. In another embodiment, although depicted as distinct steps in FIG. 9A, step 902-914 may not be distinct steps. In other embodiments, method 900 may not have all of the above steps and/or may have other steps in addition to, or instead of, those listed above. The steps and/or parts of the steps of method 900 may be performed in another order. Subsets of the steps listed above as part of method 900 may be used to form their own method.

FIG. 9B shows a flowchart of an example of a method 950 of issuing a document. In step 952, information is added to a printed document, such as a printed check by issuing institution 102 (FIG. 1A), which may be financial institution 152 and/or by a payer 162 (FIG. 1B).

In step 954, at least a part of the information added to the document is sent to database institution 160 (FIG. 1B) in association with data-structure-location-information, such as code 202 (FIGS. 2 and 3) and optionally other data-structure-location-information. Step 954 may include scanning document 112 (FIG. 1A) or document image 113 (FIG. 1A), locating code 202 (FIGS. 2 and 3), and extracting data-structure-location-information from code 202 and optionally from other document elements 204 (FIG. 2). Step 954 may also involve sending a request to update a database to database institution 160 (FIG. 1B).

In step 956, the data structure corresponding to the document is located. Step 956 may involve receiving the request to update the database from issuing institution 102 (FIG. 1A) (e.g., financial institution 152 and/or by a payer 162) to database institution 160 (FIG. 1B).

In step 958, the information added to the document is also added to the data structure therein updating the information in the database associated with database institution 160 (FIG. 1B). As part of step 958, at database institution 160, a database statement may be formed for updating the database based on the data-structure-location-information and at least a part of the information added to document 112 (FIG. 1A). Based on the database statement, database management system 702 (FIG. 7) may update the database. Optionally, an acknowledgement that the database was updated is sent from database institution 160 back to issuing institution 102 (FIG. 1A). After step 958, method 950 terminates. In FIGS. 8-9B, although not always explicitly referenced, it should be understood that the components FIGS. 5-7 may be used in performing methods 800, 900 and 950.

In an embodiment, each of the steps of method 900 is a distinct step. In another embodiment, although depicted as distinct steps in FIG. 9B, step 952-958 may not be distinct steps. In other embodiments, method 900 may not have all of the above steps and/or may have other steps in addition to, or instead of, those listed above. The steps and/or parts of the steps of method 900 may be performed in another order. Subsets of the steps listed above as part of method 900 may be used to form their own method.

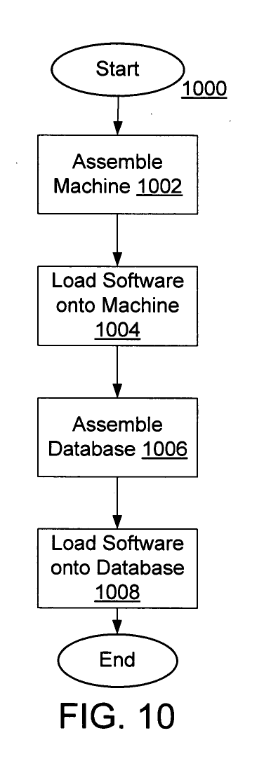

FIG. 10 is a method of configuring equipment at an institution of system 100. In step 1002, machine 105 (FIG. 1A) is assembled, which may involve assembling and communicatively linking to one another output system 502, input system 504, memory system 506, processor system 508, communications system 512, and/or input/output system 514 (FIG. 5). In step 1004 software is installed on machine 105, which may involve installing code reader 602, code creator 604, requestor 606, request handler 608, and reply sender 610, reply handler 612, comparator 614, printer driver 616, and/or scanner driver 618 (FIG. 6). Optionally a database management system (such as database management system 702 of FIG. 7) and/or a database may also be installed on machine 105.

In step 1006 database 104 (FIG. 1A) is assembled, which (similar to step 1002) may also involve assembling and communicatively linking to one another output system 502, input system 504, memory system 506, processor system 508, communications system 512, and/or input/output device 514 (FIG. 5). In step 1008, the software for database 104 is installed, which may involve installing database management system 702 (FIG. 7). Data 704 (FIG. 7) may also be installed on database 104 during step 1008. Since database 104 may be the same machine as machine 105 and since issuing institution may use a remote database, steps 1006 and 1008 are optional. All or part of method 1000 may be repeated for each institution and/or other entity in system 100.

In an embodiment, each of the steps of method 1000 is a distinct step. In another embodiment, although depicted as distinct steps in FIG. 10, step 1002-1008 may not be distinct steps. In other embodiments, method 1000 may not have all of the above steps and/or may have other steps in addition to, or instead of, those listed above. The steps and/or parts of steps of method 1000 may be performed in another order. Subsets of the steps listed above as part of method 1000 may be used to form their own method.

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A system comprising:
at least one document including at least
a code having encoded therein at least
data-location information associated with a location within a data-location, wherein the location is associated with a data structure storing at least one piece of document information associated with the document; and
other document elements, wherein outside of the data-location the information associated with the location is uncorrelated with the document.

2. The system of claim 1, wherein the code is a barcode.

3. The system of claim 1, further comprising the data-location, which stores at least some information associated with the document.

4. The system of claim 1, wherein the document also includes an identifier of a data container that is not within the code, wherein the data container is associated with the location and the data container is associated with the data-location.

5. The system of claim 4, wherein the code also has encoded therein at least information identifying the data container.

6. The system of claim 5, wherein
the code is a barcode,
the document is a check, and
the system further comprises
the data structure, which stores the at least one piece of information, wherein the at least one piece of information allows one to obtain or includes at least an account number, and
a name of an owner of the account;
a computer readable medium storing one or more instructions for creating the code.

7. The system of claim 1, wherein the code has encoded therein at least information identifying a data container associated with the data-location, wherein the data container is associated with the location.

8. The system of claim 7, wherein
the code is a barcode,
the document is a check, and
the system further comprises
the data structure, which stores the at least one piece of information, wherein the at least one piece of information allows one to obtain or includes at least an account number, and
a name of an owner of the account;
a computer readable medium storing one or more instructions for creating the code.

9. The system of claim 1, having at least two of the documents,
wherein the code of each document has at least
a first portion for information identifying a data container, and
a second portion for the information associated with the location within the data-location; and
wherein
the code associated with a first document of the at least two documents has a first ratio of a size of the first portion to the second portion, and
the code associated with a second document of the at least two documents has a second ratio of a size of the first portion to the second portion, wherein the first ratio is different from the second ratio.

10. The system of claim 1, wherein
the code is a barcode,
the document is a check, and
the system further comprises
the data structure, which stores the at least one piece of information, wherein the
at least one piece of information allows one to obtain or includes at least an account number, and
a name of an owner of the account;
a computer readable medium storing one or more instructions for creating the code.

11. A method comprising:
creating a code, wherein the code includes information indicating a location associated with a data container, wherein the data container is associated with a data-location; and
printing the code on a document, wherein outside of the data-location the information associated with the location is uncorrelated with the document.

12. The method of claim 11, further comprising:
sending information associated with the document for storing in the data-location.

13. The method of claim 11, comprising:
in association with printing the document, sending information associated with the document for storing in the data-location;
adding additional information to the document when issuing the document; and
in association with the issuing the document, sending the additional information for storing in the data-location.

14. The method of claim 12, wherein the sending of the information associated with the document includes at least sending security information associated with authentication/security features.

15. The method of claim 11, further comprising:
storing information associated with the document at the location associated with a data structure, wherein the data structure is associated with the data-location.

16. The method of claim 11, wherein the document includes at least a document element that includes at least information identifying a data container associated with the data-location.

17. The method of claim 11, wherein creating the code includes at least creating a data container portion identifying a data container.

18. The method of claim 17, wherein the document includes at least information identifying a data container, wherein the information is located outside of the code.

19. The method of claim 11, wherein the document is a check.

20. The method of claim 11, wherein the code is a barcode.

21. The method of claim 11, further comprising:
in association with printing the document, sending information associated with the document for storing in the data-location;
adding additional information to the document when issuing the document;
in association with the issuing the document, sending the additional information for storing in the data-location; and
storing information associated with the document at the location associated with a data structure, wherein the data structure is associated with the data-location; and
wherein
the sending of the information associated with the document includes at least sending security information associated with authentication/security features,
the document includes at least a document element that includes information identifying a data container associated with the data-location,
creating the code includes at least creating a data container portion identifying a data container,
the document includes at least information identifying a data container, wherein the information is located outside of the code,
the document is a check, and
the code is a barcode.

22. A method of comprising:
receiving, at a location associated with a data-location, a first set of authentication information associated with printing a document;
updating the data-location with a second set of authentication information added after printing the document.

23. The method of claim 22, wherein the document is a check.

24. The method of claim 22, wherein the second set of authentication information includes at least an amount of money associated with the document.

25. The method of claim 22, wherein the second set of authentication information includes at least a recipient designated to receive money associated with the document.

26. The method of claim 22, wherein
the document is a check; and
the second set of authentication information includes at least
an amount of money associated with the document, and
a recipient that is designated to receive the money associated with the document.

27. A method comprising:
reading a code on a document, wherein the code has at least a data-location portion that includes information associated with a location, wherein
the location is associated with information associated with the document, and
the location is associated with a data structure within a data-location, wherein
outside of the data-location the information associated with the location is uncorrelated with the document.

28. The method of claim 27, wherein the code also includes at least a data container portion containing information identifying a data container associated with the data-location.

29. The method of claim 28, further comprising sending a message to a data-location, wherein a location to which the message is sent is based on the data container portion of the code.

30. The method of claim 27, further comprising retrieving information from a location in the data-location wherein
the information is related to the document, and
the location within the data-location is based on the data-location portion of the code.

31. The method of claim 30, further comprising comparing information retrieved during the retrieving to information on the document.

32. The method of claim 31, further comprising determining whether the document is expected to be authentic based on the comparing.

33. The method of claim 27, further comprising: reading information on the document;
sending a message to a data-location, wherein a location to which the message is sent is based on the data container portion of the code;
retrieving information from a location in the data-location wherein
the information is related to the document, and
the location within the data-location is based on the data-location portion of the code;
comparing information retrieved during the retrieving to information read during the reading; and
determining whether the document is expected to be authentic based on the comparing.

34. The method of claim 33, wherein
the document is a check, and
the code is a barcode.

35. A method comprising: receiving a request for information associated with a document, wherein the request includes data indicating a location within a data-location where the information is found, wherein outside of the data-location the data is uncorrelated with information associated with the document;
retrieving the information based on the data.

36. The method of claim 35, wherein
the code is a barcode,
the code includes at least
a data-location portion, which includes at least the data indicating, and
a data container portion containing information identifying a data container associated with the data-location,
the request also includes information associated with the document, and
the method further comprises
prior to the receiving,
creating the code,
storing the information associated with the document in the data-location, and
issuing the document, wherein the document has the code printed thereon; and
after the receiving,
sending the information found to a source of the request
comparing the information from the document in the request to information retrieved during the retrieving, and
determining whether the document is expected to be authentic based on the comparing.

37. The method of claim 36, wherein the method further comprises:
after the issuing and prior to the receiving
reading information on the document, and
sending a message to the data-location, wherein a location to which the message is sent is based on the data container portion of the code.

38. A system comprising one or more machine readable media storing thereon one or more instructions for carrying out the method of claim 11.

39. A system comprising a machine readable medium storing thereon one or more instructions for carrying out the method of claim 22.

40. A system comprising
a machine readable medium storing thereon one or more instructions for carrying out the method of claim 33; wherein the document is a first document;
the code is a barcode
the document is a check, and
the system further comprises
the data-location, which stores the at least one piece of information, wherein the
at least one piece of information includes at least or facilitates obtaining at least
an account number, and
a name of an owner of the account; and
a processor for implementing the one or more instructions.
